(19) United States
(12) Patent Application Publication
(10) Pub. No.: US 2026/0036076 A1
(43) Pub. Date: Feb. 5, 2026

(54) AFTERCOOLER FOR INTERNAL COMBUSTION ENGINE

(71) Applicant: Caterpillar Inc., Peoria, IL (US)

(72) Inventors: Dongming Tan, Eastvale, CA (US); Rohit K. Paramatmuni, Peoria, IL (US); Anthony L. De Luca, Germantown Hills, IL (US); Jianlong Xu, Dunlap, IL (US); Zheng Zhang, Dunlap, IL (US)

(73) Assignee: Caterpillar Inc., Peoria, IL (US)

(21) Appl. No.: 18/792,022

(22) Filed: Aug. 1, 2024

(51) Int. Cl. F02B 29/04

(52) U.S. Cl. CPC F02B 29/0462

(57) ABSTRACT

An aftercooler for an internal combustion engine is shown and described herein. The aftercooler can include a first header plate and a manifold assembly configured to receive a cooling fluid coupled to a first side of the first header plate. A core assembly is positioned adjacent a second side of the first header plate and configured to receive and cool a charge air for the internal combustion engine. The core assembly can include: a plurality of tubes coupled to the first header plate to receive the cooling fluid from the manifold assembly; a first plurality of fins that receive some of the plurality of tubes; and second plurality of fins that receive a further of the plurality of tubes. The first plurality of fins includes a first end that interfaces with a second end the second plurality of fins thereby forming a joint therebetween.

### TECHNICAL FIELD

The present disclosure relates to internal combustion engines. More particularly, the present disclosure relates to an aftercooler that includes fins as heat transfer elements for the aftercooler.

### BACKGROUND

Machinery, for example, military, marine transport, agricultural, industrial, construction or other heavy machinery can be propelled by one or more internal combustion engine(s). Internal combustion engines combust a mixture of air and fuel in cylinders and thereby produce drive torque and power.

A turbocharger can be employed on an internal combustion engine, particularly one operating on diesel fuel, for increasing a pressure of intake air (also called charge or boost air) entering combustion chambers of the engine. An aftercooler, also known as a charge air cooler, is positioned to control the temperature of the intake air after it has traveled through the turbocharger. The primary function of the aftercooler is to lower the temperature of the compressed intake air produced by the turbocharger, thereby increasing the air density, allowing for more efficient combustion within the engine.

Various heat exchangers have been designed that utilize fins to facilitate heat exchange. Examples of such systems include U.S. Patent Application Publication No. US20030106677A1 and French Application Publication No. FR2538525A1. However, these heat exchangers differ from the present application in various ways. For example, the heat exchangers of the '677A1 and '525A1 applications are not used as part of aftercoolers of an internal combustion engine. Additionally, the heat exchangers of these applications utilize slotted fins to create additional pathways for heat flow. This slotted fin configuration is not the focus of the present application.

### SUMMARY

In an example according to this disclosure aftercooler for an internal combustion engine optionally includes: a first header plate; a manifold assembly coupled to a first side of the first header plate, wherein the manifold assembly is configured to receive a cooling fluid; and a core assembly positioned adjacent a second side of the first header plate, the core assembly is configured to receive and cool a charge air for the internal combustion engine, the core assembly comprising: a plurality of tubes coupled to the first header plate and receiving the cooling fluid from the manifold assembly; a first plurality of fins receiving some of the plurality of tubes; and a second plurality of fins receiving further of the plurality of tubes, wherein one or more of the first plurality of fins includes, a first end that interfaces with a second end of one or more of the second plurality of fins thereby forming a joint therebetween.

In another example according to this disclosure, an aftercooler for cooling a charge air of an internal combustion engine, the aftercooler optionally includes: a first header plate; a core assembly positioned adjacent the first header plate, the core assembly comprising: a plurality of tubes coupled to the first header plate; a plurality of rows of fins, wherein one or more of the plurality of rows of fins includes, a first fin receiving some of the plurality of tubes; and a second fin receiving further of the plurality of tubes, wherein the first fin has a first end and the second fin has a second end, wherein the first end forms a joint with the second end.

In yet another example according to this disclosure, a method of assembling an aftercooler of an internal combustion engine, the method optionally including: providing a first header plate; coupling a plurality of tubes to the first header plate; coupling a first number of the plurality of tubes to a first plurality of fins; coupling a second number of the plurality of tubes to a second plurality of fins; and arranging a respective first end of one or more of the first plurality of fins to interface with a respective second end of one or more of the second plurality of fins.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of a portion of an internal combustion engine having an intake air system including an aftercooler, in accordance with an example of this disclosure.

FIG. 2A is an exploded view of the aftercooler, in accordance with an example of this disclosure.

FIG. 2B is a perspective view of the aftercooler of FIG. 2A with a schematic of various exemplary flow circuits therethrough, in accordance with an example of the present application.

FIG. 3 is a perspective view of the aftercooler with components such as a header plate removed to further illustrate components of a core assembly such as a plurality of tubes and a plurality of fins, in accordance with an example of the present application.

FIG. 4 is an enlarged a perspective view of a portion of some of a plurality of rows of the plurality of fins of FIG. 3 and illustrates a first plurality of first fins and a second plurality of second fins arranged with interfacing ends forming a joint, in accordance with an example of the present application.

FIG. 5 is a perspective view of single row of the plurality of fins with the plurality of tubes removed, wherein the singe row of the plurality of fins has a first fin separated from a second fin by the joint, in accordance with an example of the present application.

FIG. 6 is a perspective view of single row of the plurality of fins with the plurality of tubes removed, wherein the singe row of the plurality of fins has a first fin separated from a second fin and the second fin separated from a third fin by a joint, in accordance with an example of the present application.

FIG. 7 is a perspective view with the plurality of fins removed showing the plurality of tubes coupled to a header plate at a plurality of second joints, in accordance with an example of the present application.

### DETAILED DESCRIPTION

Examples according to this disclosure are directed to internal combustion engines, air intake systems thereof and components including an aftercooler. Examples of the present disclosure are now described with reference to the accompanying drawings. The following description is merely exemplary in nature and is not intended to limit the present disclosure, application, or use. Examples described set forth specific components, devices, and methods, to provide an understanding of embodiments of the present disclosure. It will be apparent to those skilled in the art that specific details need not be employed and that examples may be embodied in many different forms. Thus, the examples provided should not be construed to limit the scope of the claims.

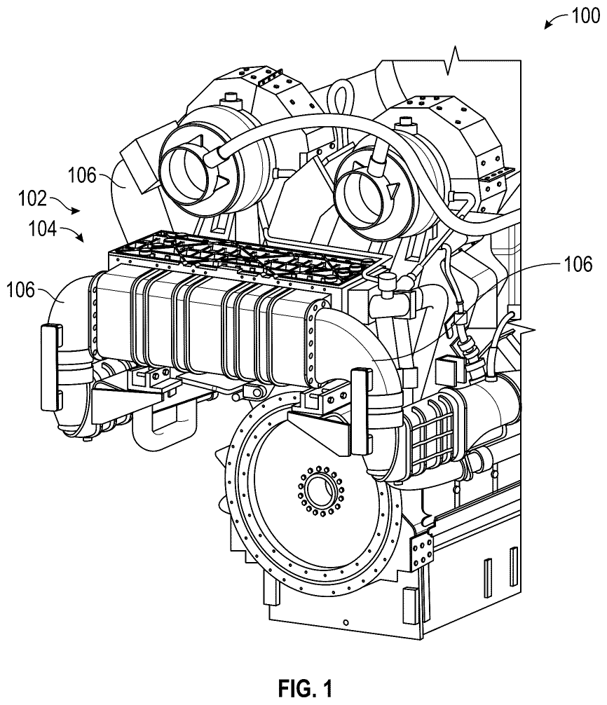

FIG. 1 depicts a portion of an internal combustion engine 100 in accordance with this disclosure. The internal combustion engine 100 can be used for power generation such as for the propulsion of vehicles or other machinery. The internal combustion engine 100 can include various power generation platforms, including, for example, gasoline, natural gas, diesel or any other desired fuel. It is understood that the present disclosure can apply to any number of piston-cylinder arrangements and a variety of internal combustion engine configurations including, but not limited to, V-internal combustion engines, inline internal combustion engines, and horizontally opposed internal combustion engines, as well as overhead cam and cam-in-block configurations.

In some applications, the internal combustion engines such as internal combustion engine 100 can be used in stationary applications such as for power generation. In other applications the internal combustion engines disclosed can be used with vehicles and machinery that include those related to various industries, including, as examples, construction, marine transport, military, agriculture, forestry, other transportation, material handling, waste management, etc. The internal combustion engine 100 is configured to operatively drive a load, for example, an electrical generator or other device. The internal combustion engine 100 is mechanically coupled to the generator or other device by an output shaft (e.g., a crankshaft).

The internal combustion engine 100 can include an intake air system 102 including an aftercooler 104 and ducting 106 and various other components such as a supercharger or turbocharger that are not specifically illustrated in FIG. 1. The intake air system 102 can communicate compressed intake air (boost or charge air) from the supercharger or turbocharger through the aftercooler 104 and on to a plurality of combustion chambers of the internal combustion engine 100 and other components known in the art.

The aftercooler 104 is configured to receive the compressed intake air from the ducting 106, pass the intake air through a heat exchange relationship to cool the intake air and then pass the cooled intake air (referred to elsewhere herein as charge air) via the ducting 106 to the combustion chambers of the internal combustion engine 100. The aftercooler 104 can be configured to use at least a second fluid (e.g., jacket water, other water, oil, coolant, water-glycol, air, mixtures thereof, etc.) as a cooling fluid. In some examples, two or more different cooling fluids or a same fluid but with separate fluid flows at different temperatures can be used as the cooling fluid. The cooling fluid can be in a heat exchange relationship with the charge air within a core assembly (not shown) of the aftercooler 104. The internal combustion engine 100 can be provided with an intake manifold being in fluid communication with each of the plurality of combustion chambers by the ducting 106 or other mechanism.

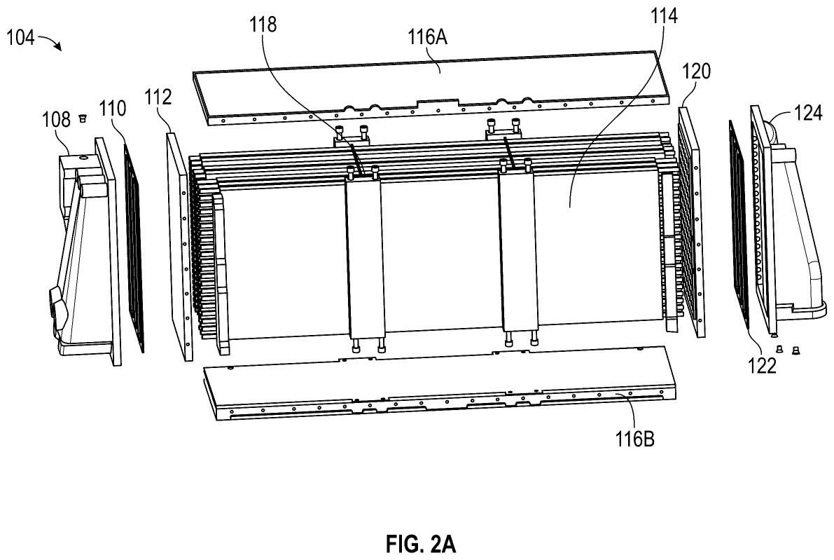

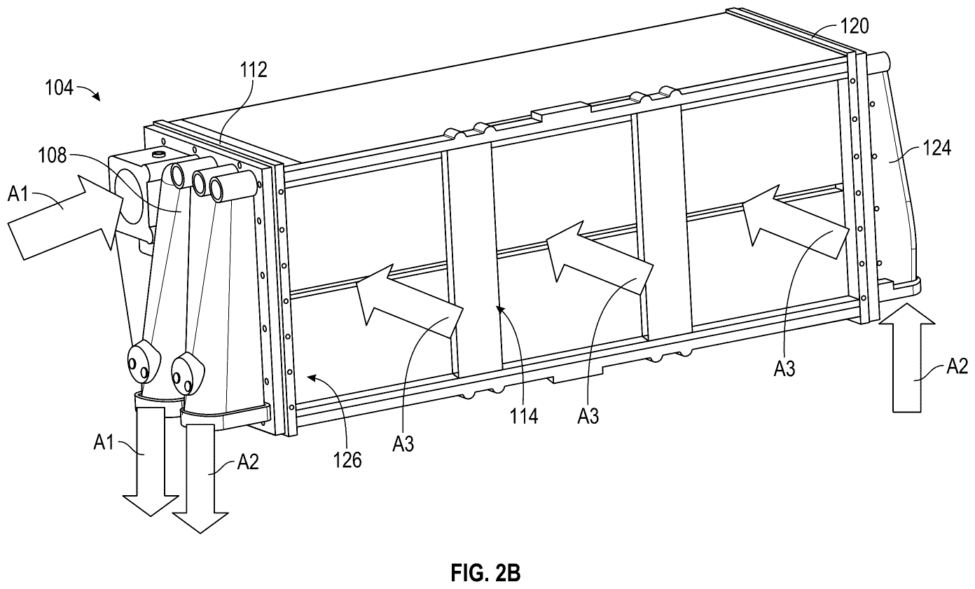

FIG. 2A is an exploded view of the aftercooler 104 according to one embodiment. The aftercooler 104 has an open frame construction for communicating with the ducting 106 (not shown but illustrated in FIG. 1) and can include a first manifold assembly 108, a first gasket 110, a first header plate 112, a core assembly 114, a first side sheet 116A, a second side sheet 116B, one or more tie bars 118, a second header plate 120, a second gasket 122 and a second manifold assembly 124.

The first manifold assembly 108 can be coupled to ducting, piping, lines, etc. (not shown but piping examples illustrated but not labeled in FIG. 1) for introduction or outflow of one or more cooling fluid(s). The first manifold assembly 108 can be coupled to a first side of the first header plate 112 with the first gasket 110 positioned between the first manifold assembly 108 and the first header plate 112. The first gasket 110 can separate different types or different temperatures of the cooling fluid(s), for example.

The core assembly 114 can be positioned adjacent a second side of the first header plate 112. Components of the core assembly 114 such as the plurality of tubes (discussed and shown subsequently) can extend into and can be coupled with the first header plate 112 according to some embodiments. In operation, the core assembly 114 is configured to receive both the cooling fluid(s) from the first manifold assembly 108 and receive the charge air. The core assembly 114 can cool the charge air for the internal combustion engine using the cooling fluid(s). The core assembly 114 can have an elongate extent and can be constructed of suitable material(s) such as heat conductive metal(s) (e.g., copper, nickel, or combinations thereof). The core assembly 114 can include a plurality of flow passages allowing the charge air to pass therebetween in the heat conductive relationship with the cooling fluid. Similarly, the core assembly 114 can have a plurality of flow passages allowing the cooling fluid(s) to pass therethrough.

The first side sheet 116A and the second side sheet 116B can be positioned adjacent opposing ends of the core assembly 114. The first side sheet 116A and the second side sheet 116B can be configured to partially contain the flow of the charge air through the core assembly 114. The one or more tie bars 118 can extend between the first side sheet 116A and the second side sheet 116B and can be coupled thereto. The one or more tie bars 118 can be positioned adjacent and to either side of the core assembly 114.

The second header plate 120 can be positioned adjacent the core assembly 114 on an opposing side thereof from the first header plate 112. Components of the core assembly 114 such as the plurality of tubes (discussed and shown subsequently) can extend into and can be coupled with the second header plate 120 according to some examples. The second manifold assembly 124 can be coupled to the second header plate 120. The second gasket 122 can be positioned between the second manifold assembly 124 and the second header plate 120. The second gasket 122 can separate different types or different temperatures of the cooling fluid(s), for example.

The aftercooler 104 can have an open frame design with openings 126 (only one illustrated in FIG. 2B) that allow for passage of the charge air to the core assembly 114. Although not shown in FIGS. 2A and 2B, ducting 106 of the intake air system 102 (FIG. 1) can be placed over and coupled to ends of the first side sheet 116A and the second side sheet 116B and/or to other components for conveying the charge air to and from the core assembly 114.

FIG. 2B illustrates example flows of a first cooling fluid (arrows A1), a second cooling fluid (arrows A2) and the charge air (arrows A3) through the aftercooler 104. It should be noted that the flow circuits of FIG. 2B are purely exemplary and the concepts of the present application are applicable to other aftercooler designs including those that only utilize a single cooling fluid or three or more cooling fluids. Furthermore, the cross-flow and/or cooling flow circuit geometries illustrated are purely exemplary and can be modified according to further examples.

In the example of FIG. 2B, the aftercooler 104 is configured for two stages of cooling of the charge air including higher temperature cooling and lower temperature cooling. Thus, for example, the first manifold assembly 108 can be configured to receive the first cooling fluid (e.g., lower temperature water, coolant, oil, lower temperature air, etc.) and pass this to a first section of the core assembly 114 and through the core assembly 114 to the second manifold assembly 124. According to the embodiment of FIG. 2B, the aftercooler 104 is configured such that the first cooling fluid turns in the second manifold assembly 124 and re-enters the core assembly 114 passing back through a second section of the core assembly 114 to the first manifold assembly 108 and then exits therefrom into ducting (not shown).

The second manifold assembly 124 can additionally be configured to receive the second cooling fluid (e.g., jacket water at higher temperature, other water at higher temperature, higher temperature oil, higher temperature air, etc.) and pass this to another higher temperature section of the core assembly 114 and through the core assembly 114 to the first manifold assembly 108. The second cooling fluid can be discharged from the first manifold assembly 108 as shown in FIG. 2B. However, other embodiments for the aftercooler contemplate that the second cooling fluid could be passed back through the core assembly 114 in an opposing direction in the manner of the first cooling fluid.

FIG. 2B shows the charge air flowing into and through the core assembly 114 via one of the openings 126 in a direction generally perpendicular to the flow direction of the first cooling fluid and the second cooling fluid. This cross-flow heat transfer arrangement results in cooling of the charge air for use in the combustion chambers as described previously.

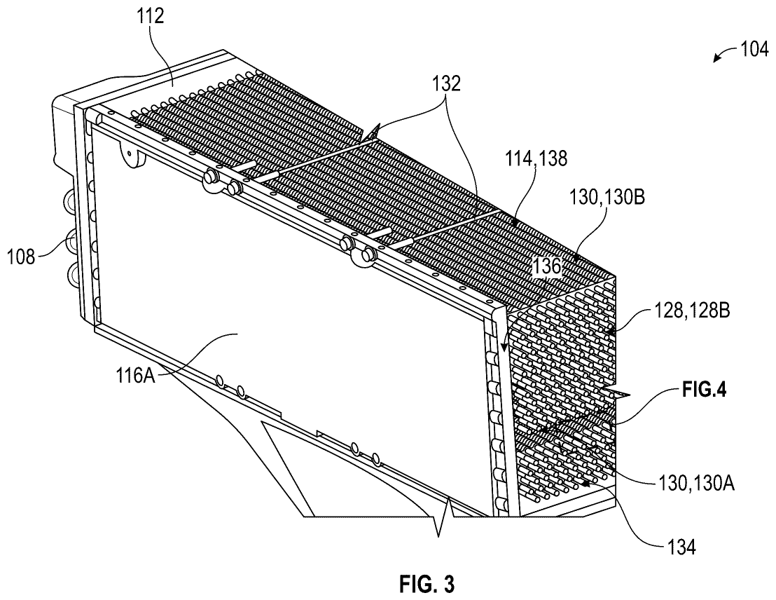

FIG. 3 shows the aftercooler 104 from a different perspective than FIGS. 2A and 2B with the first side sheet 116A and the second side sheet 116B to the left and right side of the core assembly 114 rather than being above and below as was previously the case. Additionally, the second manifold assembly 124 (FIG. 2) and the one or more tie bars 118 (FIG. 2) are removed in FIG. 3 to show further details of the core assembly 114. FIG. 3 shows the first manifold assembly 108, the first header plate 112, the core assembly 114, the first side sheet 116A and the second side sheet 116B as previously discussed. Additionally, the core assembly 114 as shown in FIG. 3 includes a plurality of tubes 128, a plurality of fins 130 and one or more stiffener plates 132.

FIG. 3 shows the aftercooler 104 having the core assembly 114 separated into a higher temperature stage 134 and a lower temperature stage 136 as previously discussed in FIG. 2B. The higher temperature stage 134 can be spaced from the lower temperature stage 136.

As shown in FIG. 3, the plurality of tubes 128 can extend through and can be received by the plurality of fins 130. The plurality of tubes 128 can transport the cooling fluid(s) through the core assembly 114. The plurality of tubes 128 can have a diameter that can vary according to aftercooler application. Only the ends of the plurality of tubes 128, which are typically be coupled to the header plate are shown in FIG. 3 as the remainder of the elongate length thereof is blocked by the plurality of fins 130.

The plurality of fins 130 can be elongate but relatively thin plate-like structures. The plurality of fins 130 can be arranged in a plurality of rows 138 spaced substantially parallel to one another and to the first header plate 112. The plurality of rows 138 extend between (but are spaced from) the first side sheet 116A and the second side sheet 116B. The orientation of the plurality of fins 130 spaced in the plurality of rows 138 creates passages/gaps for flow of the charge air therebetween as previously discussed. Spacing of the plurality of rows 138 can vary with application and type of the aftercooler. As an example, multiple rows of the plurality of fins 130 can be arranged per centimeter. The plurality of tubes 128 and the plurality of fins 130 can be constructed of suitable material(s) such as heat conductive metal(s) (e.g., copper, nickel, or combinations thereof).

As shown in FIG. 3, the plurality of tubes 128 can be coupled with respectively arranged groups of the plurality of fins 130. The plurality of tubes 128 can support the plurality of fins 130 within the aftercooler 104. The plurality of tubes 128 can be arranged in several groups. These groups include a plurality of tubes 128A received by a plurality of fins 130A of the higher temperature stage 134, and another plurality of tubes 128B received by a plurality of fins 130B of the lower temperature stage 136, for example. It should be noted that the lower temperature stage 136 can be further broken into third pluralities of the fins and tubes not specifically numbered. This is due to the out-and-back flow of the lower temperature cooling fluid as discussed previously.

The one or more stiffener plates 132 are positioned at intervals along the elongate length of the core assembly 114. The one or more stiffener plates 132 support the plurality of tubes 128. The one or more stiffener plates 132 are coupled to the one or more tie bars (not shown in FIG. 3 but shown previously in FIGS. 2A and 2B) and are positioned between the first header plate 112 and the second header plate (not shown) and the first side sheet 116A and the second side sheet 116B.

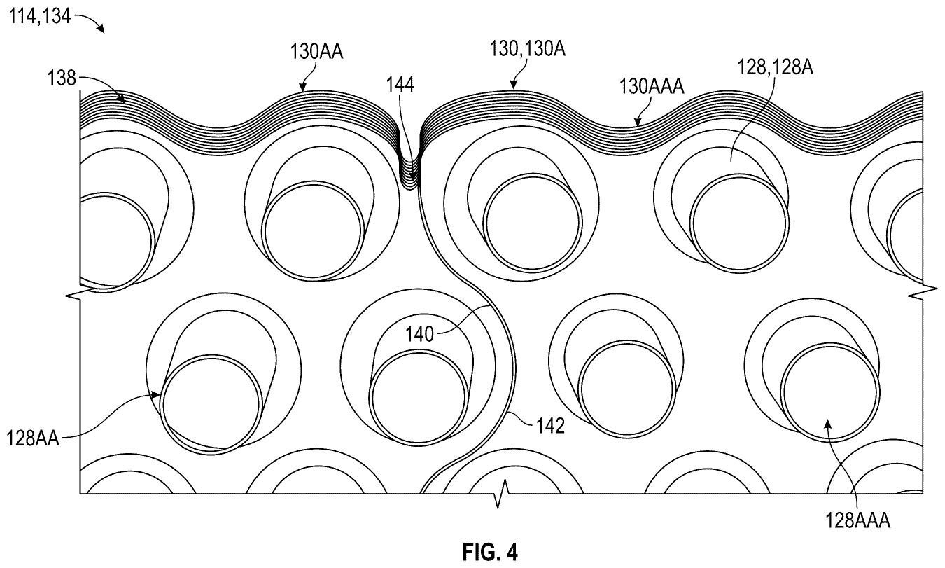

FIG. 4 is an enlarged view of an end portion of the higher temperature stage 134 of the core assembly 114. Thus, FIG. 4 shows a portion of some of the plurality of tubes 128 (specifically some of the plurality of tubes 128A), a portion of some of the plurality of fins 130 (specifically some of the plurality of fins 130A) and some (e.g., 8 to 10) of the plurality of rows 138 of the plurality of fins 130.

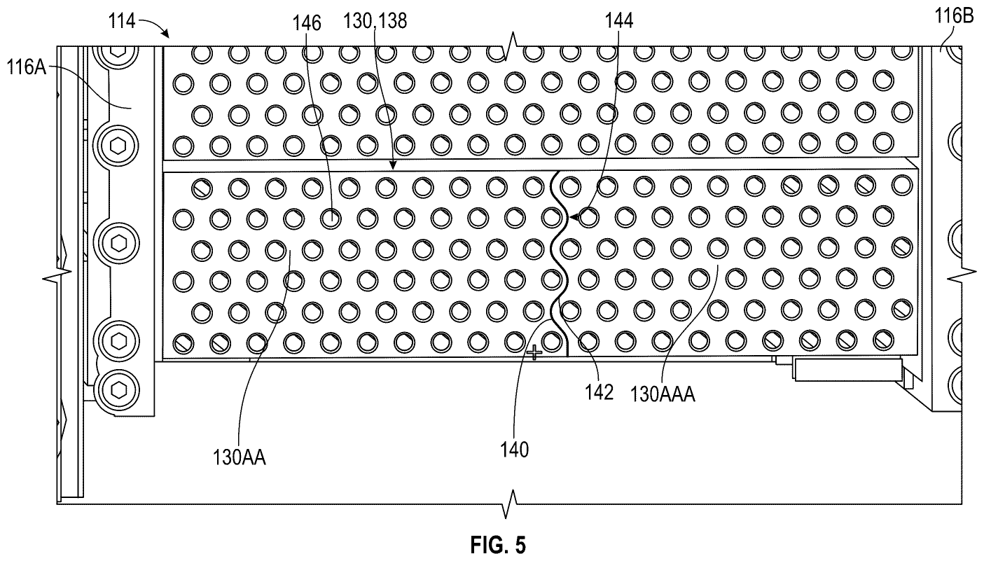

FIG. 4 shows an arrangement of where the plurality of fins 130 in a respective row are split/separated rather than having a row formed of a single fin extending from adjacent first side sheet 116A (FIG. 3 or 5) to the second side sheet 116B (FIG. 3 or 5). Thus, the plurality of fins 130 include a first plurality of fins 130AA that receive some of the plurality of tubes 128 (indicated as first group of tubes 128AA) and a second plurality of fins 130AAA that receive further of the plurality of tubes 128 (indicated as second group of tubes 128AAA). As arranged in FIG. 4, a respective one or more (including up to all) of the first plurality of fins 130AA includes a first end 140 that interfaces with a second end 142 of a respective one or more (including up to all) of the second plurality of fins 130AAA thereby forming a joint 144 therebetween. As discussed previously, the first plurality of fins 130AA can be at least partially or wholly supported by the first group of tubes 128AA within the core assembly 114 and the second plurality of fins 130AAA can be at least partially or wholly supported by the second group of tubes 128AAA.

The joint 144 can have substantially a serpentine shape when viewed from an end (e.g., from a perspective of the first header plate or the second header plate). The joint 144 can be formed by respective ones the first plurality of fins 130AA abutting respective ones of the second plurality of fins 130AAA or by a gap of between 0.5 mm to 1 cm, inclusive between one or more the respective ones the first plurality of fins 130AA and one or more respective ones of the second plurality of fins 130AAA. Put another way, the first end 140 abuts or can be separated by a gap from the second end. 142.

FIG. 5 is a perspective end view of one (an outermost) of the plurality of rows 138 of the plurality of fins 130 of the core assembly 114 with the plurality of tubes removed to illustrate apertures 146 that that receive respective ones of the plurality of tubes. Thus, FIG. 5 shows one of the plurality of rows 138 of the plurality of fins 130 and further shows the joint 144. The joint 144 is between a first end 140 of a first fin 130AA that is one of the first plurality of fins 130AA previously shown in FIG. 4 and a second end 142 of a second fin 130AAA that is one of the second plurality of fins 130AAA. As shown in FIG. 5, the first end 140 forms the joint 144 with the second end 142. As further shown in FIG. 5, the first fin 130AA and the second fin 130AAA together are arranged end-to-end to extend from adjacent the first side sheet 116A to adjacent the second side sheet 116B.

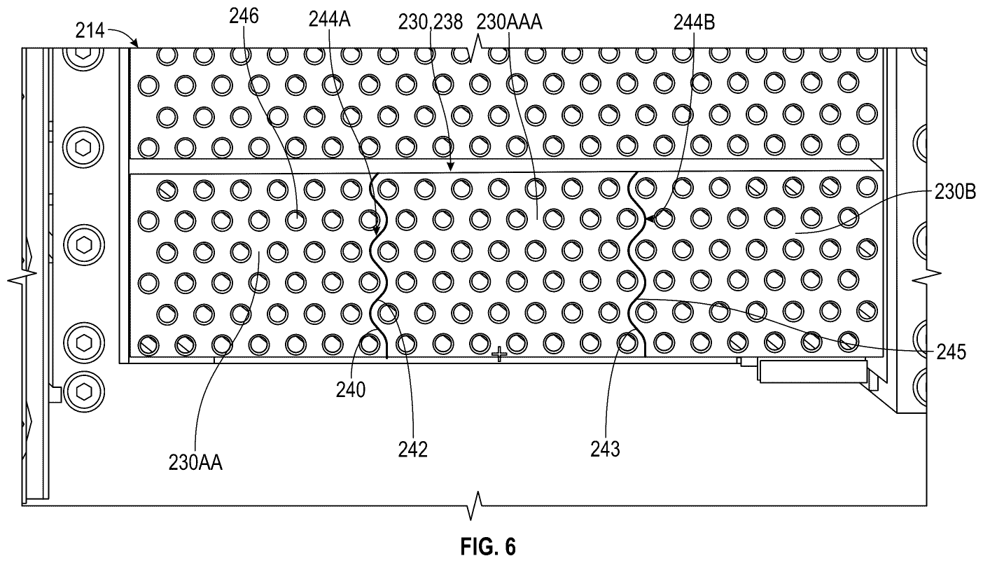

FIG. 6 shows a portion of a core assembly 214 according to another embodiment. Like FIG. 5, FIG. 6 shows a perspective end view of one (an outermost) of a plurality of rows 238 of a plurality of fins 230 of the core assembly 214 with a plurality of tubes removed to illustrate apertures 246 that that receive respective ones of the plurality of tubes. Thus, FIG. 6 shows one of the plurality of rows 238 of the plurality of fins 230 and further shows joints 244A and 244B formed between some of the plurality of fins 230. The joint 244A is between a first end 240 of a first fin 230AA that is one of a first plurality of fins 230AA and a second end 242 of a second fin 230AAA that is one of a second plurality of fins 230AAA. FIG. 6 further shows a third fin 230B that is configured to receive yet further of the plurality of tubes via the apertures 246. The second fin 230AAA includes a third end 243 opposing the second end 242 that interfaces with a fourth end 245 of the third fin 230B thereby forming the second joint 244B between the second fin 230AAA and the third fin 230B.

Although two joints and three fins are shown for the one of the plurality of rows 238 in the example of FIG. 6, further embodiments contemplate three or more joints and four or more fins arranged for a single row of the plurality of rows 238. Additionally, although FIGS. 3-6 illustrate the concept of having the plurality of fins 130 or 230 on a per row basis be split/separated for the higher temperature stage, further embodiments contemplate the concept could be used on only a portion of the higher temperature stage or could be applied in the lower temperature stage or another stage.

### INDUSTRIAL APPLICABILITY

In operation, the internal combustion engine 100 can be configured to combust fuel to generate power. During operation, the internal combustion engine 100 can utilize charge air for combustion to improve efficiency. The present application contemplates use of the aftercooler 104 for cooling the charge air by heat exchange within the core assembly 114. Heat exchange with the charge air is accomplished by passing the charge air over a plurality of fins 130 or 230 arranged in a plurality of rows 138 (or plurality of rows 238). FIGS. 4-6 show embodiments where the plurality of fins 130 (or plurality of fins 230) in a respective row of the plurality of rows 138 or 238 are split/separated into two or more end-to-end fins rather than having the row formed from a single fin extending from adjacent first side sheet 116A to the second side sheet 116B.

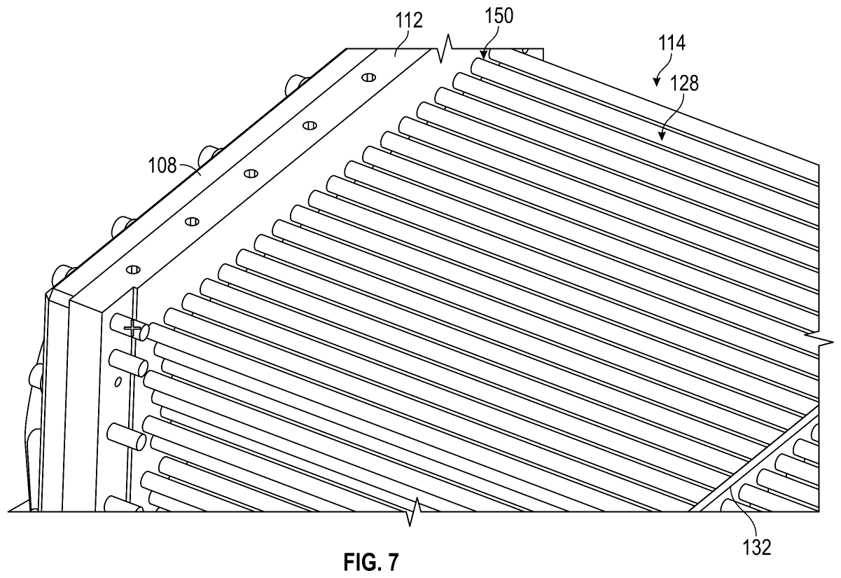

FIG. 7 shows a portion of the core assembly 114 with the plurality of fins, the first side sheet and the second side sheet removed to show the first manifold assembly 108, the first header plate 112, a portion of one of the stiffener plates 132 and the plurality of tubes 128. The plurality of tubes 128 couple with the first header plate 112 at a joint 150 (a tube header joint). The plurality of tubes 128 are in fluid communication with the first manifold assembly 108 and can thereby receive or communicate the cooling fluid(s) from or to the first manifold assembly 108 as previously discussed. The present application has determined that use of the joint 144 of FIGS. 4 and 5 (or joints 244A and 244B of FIG. 6) can reduce the thermal stress on the tube header joints (the joint 150). This is due to the relatively smaller extent of the fins having less thermal expansion and contraction. As a consequence of the shortened fin design and the end-to-end arrangement utilizing joint 144 (or joints 244A and 244A), thermal stress is reduced and a thermal cycle life of the joint 150 (and hence the plurality of tubes 128) is improved.

Additionally, the present application contemplates a method of assembling an aftercooler (e.g., aftercooler 104) of an internal combustion engine (e.g., internal combustion engine 100). The method can include providing a first header plate (e.g., first header plate 112). The method can include coupling a plurality of tubes (e.g., the plurality of tubes 128 or the plurality of tubes 238) to the first header plate. The method can include coupling a first number of the plurality of tubes to a first plurality of fins (e.g., the first plurality of fins 130AA or first plurality of fins 230AA). The method can include coupling a second number of the plurality of tubes to a second plurality of fins (e.g., the second plurality of fins 130AAA or second plurality of fins 230AAA). The method can include arranging a respective first end (e.g., the first end 140) of one or more of the first plurality of fins to interface with a respective second end (e.g., the second end 142) of one or more of the second plurality of fins. The method can further include, for example, assembling the aftercooler with a higher temperature stage and a lower temperature stage, where the joint between the respective first end of one of the first plurality of fins with the respective second end of one of the second plurality of fins occurs only for the higher temperature stage. The method can include arranging the first plurality of fins and the second plurality of fins in a plurality of rows between the first header plate and a second header plate. The method can include coupling a third number of the plurality of tubes with a third plurality of fins and arranging a respective third end of the one of the second plurality of fins with a respective fourth end of one of the third plurality of fins.

The above detailed description is intended to be illustrative, and not restrictive. The scope of the disclosure should, therefore, be determined with references to the appended claims, along with the full scope of equivalents to which such claims are entitled.

What is claimed is:

1. An aftercooler for an internal combustion engine comprising:
a first header plate;
a manifold assembly coupled to a first side of the first header plate, wherein the manifold assembly is configured to receive a cooling fluid; and
a core assembly positioned adjacent a second side of the first header plate, the core assembly is configured to receive and cool a charge air for the internal combustion engine, the core assembly comprising:
a plurality of tubes coupled to the first header plate and receiving the cooling fluid from the manifold assembly;
a first plurality of fins receiving some of the plurality of tubes; and
a second plurality of fins receiving further of the plurality of tubes, wherein one or more of the first plurality of fins includes a first end that interfaces with a second end of one or more of the second plurality of fins thereby forming a joint therebetween.

2. The aftercooler of claim 1, wherein the joint has a serpentine shape.

3. The aftercooler of claim 1, wherein the core assembly is separated into a higher temperature stage and a lower temperature stage, and wherein the joint between the first plurality of fins and the second plurality of fins occurs only for the higher temperature stage.

4. The aftercooler of claim 1, wherein the core assembly further includes:
a second header plate;
a second manifold assembly coupled to the second header plate;
one or more tie bars; and
one or more stiffener plates supporting the plurality of tubes, and wherein the one or more stiffener plates are coupled to the one or more tie bars and positioned between the first header plate and the second header plate;
wherein the first plurality of fins and the second plurality of fins are arranged in a plurality of rows between the first header plate and the second header plate.

5. The aftercooler of claim 1, further comprising at least a third plurality of fins receiving yet further of the plurality of tubes, wherein one or more of the second plurality of fins includes a third end opposing the second end that interfaces with a fourth end of the third plurality of fins thereby forming a second joint between the second plurality of fins and the third plurality of fins.

6. The aftercooler of claim 1, wherein the joint reduces a thermal stress at a joint between the plurality of tubes and the first header plate.

7. The aftercooler of claim 1, wherein the first end abuts or is separated by a gap from the second end.

8. An aftercooler for cooling a charge air of an internal combustion engine, the aftercooler comprising:
a first header plate;
a core assembly positioned adjacent the first header plate, the core assembly comprising:
a plurality of tubes coupled to the first header plate;
a plurality of rows of fins, wherein one or more of the plurality of rows of fins includes a first fin receiving some of the plurality of tubes;
and a second fin receiving further of the plurality of tubes, wherein the first fin has a first end and the second fin has a second end, wherein the first end forms a joint with the second end.

9. The aftercooler of claim 8, wherein the joint has a serpentine shape.

10. The aftercooler of claim 8, wherein the core assembly is separated into a higher temperature stage and a lower temperature stage, and wherein the joint between the first fin and the second fin occurs only for the higher temperature stage.

11. The aftercooler of claim 8, wherein the core assembly further includes:
a second header plate;
a first side sheet extending between the first header plate and the second header plate;
a second side sheet spaced from the first side sheet, wherein the second side sheet extends between the first header plate and the second header plate; and
one or more tie bars extending between the first side sheet and the second side sheet;
wherein the plurality of rows of fins are positioned between the first side sheet and the second side sheet such that the first fin and the second fin together extend from adjacent the first side sheet to adjacent the second side sheet.

12. The aftercooler of claim 8, further comprising at least a third fin receiving yet further of the plurality of tubes, wherein the second fin includes a third end opposing the second end that interfaces with a fourth end of the third fin thereby forming a second joint between the second fin and the third fin.

13. The aftercooler of claim 8, wherein the joint reduces a thermal stress at a joint between the plurality of tubes and the first header plate.

14. The aftercooler of claim 8, wherein the first end abuts or is separated by a gap from the second end.

15. A method of assembling an aftercooler of an internal combustion engine comprising:
providing a first header plate;
coupling a plurality of tubes to the first header plate;
coupling a first number of the plurality of tubes to a first plurality of fins;
coupling a second number of the plurality of tubes to a second plurality of fins; and
arranging a respective first end of one or more of the first plurality of fins to interface with a respective second end of one or more of the second plurality of fins.

16. The method of claim 15, wherein the arranging is along a serpentine shaped joint.

17. The method of claim 16, further comprising assembling the aftercooler with a higher temperature stage and a lower temperature stage, and wherein the joint between the respective first end of one of the first plurality of fins with the respective second end of one of the second plurality of fins occurs only for the higher temperature stage.

18. The method of claim 15, further comprising arranging the first plurality of fins and the second plurality of fins in a plurality of rows between the first header plate and a second header plate.

19. The method of claim 15, further comprising:
coupling a third number of the plurality of tubes with a third plurality of fins; and
arranging a respective third end of the one of the second plurality of fins with a respective fourth end of one of the third plurality of fins.

20. The method of claim 15, wherein the respective first end abuts or is separated by a gap from the respective second end.
